(19) United States
(12) Patent Application Publication
(10) Pub. No.: US 2016/0039289 A1
(43) Pub. Date: Feb. 11, 2016

(54) Method and Device for Increasing the Security when using Battery Modules

(71) Applicants: ROBERT BOSCH GMBH, Stuttgart (DE); SAMSUNG SDI CO., LTD., Yongin-si, Gyeonggi-do (KR)

(72) Inventor: Holger Fink, Stuttgart (DE)

(73) Assignee: Samsung SDI Co., Ltd., Yongin-si, Gyeonggi-do (KR)

(21) Appl. No.: 14/776,426

(22) PCT Filed: Feb. 10, 2014
(86) PCT No.: PCT/EP2014/052538

§ 371 Date: Sep. 14, 2015

(30) Foreign Application Priority Data
Mar. 15, 2013 (DE) 10 2013 204 519.0

(51) Int. Cl. B60L 3/04; B60L 11/18

(52) U.S. Cl. CPC B60L 3/04; B60L 11/1851

(57) ABSTRACT

A method for inducing a secure state of a battery module of a motor vehicle includes continuously checking and evaluating a current state of the battery module. The secure state of the battery module to be induced is a state, in which effects of a defective battery module are reduced. The secure state is induced in dependence of a motor vehicle state.

### FIELD OF THE INVENTION

The present invention relates to a method and a device for increasing safety when using battery modules in accordance with the preamble of the independent claims.

### PRIOR ART

Safety concepts for intrinsically safe battery modules are known from the prior art. By way of example, protective fuses and measures that prevent or counteract high currents and voltages in the region of the battery modules are known from the prior art. By way of example, DE102011113798A1 discloses a modular battery, wherein individual series and parallel circuits of the battery module can be connected and disconnected so as to avoid dangers that are associated with the battery.

### DISCLOSURE OF THE INVENTION

The invention is based on a method for transferring a battery module of a vehicle into a safe state wherein the prevailing state of the battery module is continuously monitored and evaluated and the safe state into which the battery module is to be transferred is a type of safe state in which the effects of a defective battery module are reduced.

The core of the invention resides in the fact that the battery module is transferred into the safe state in dependence upon a vehicle state in accordance with the characteristic features of the independent claims.

The background of the invention is to increase safety when handling the battery modules and to reduce the effects of defective battery modules on the environment. A transfer of the battery module into the safe state in dependence upon the vehicle state has two advantages: firstly, the transfer in dependence upon the vehicle state leads to a needs-based transfer into said safe state, consequently to a transfer that is not performed in a general manner. A needs-based transfer of the battery module into the safe state leads to a reduced loading on the systems that are used to perform said transfer and their components. Secondly, measures that in fact increase the safety in connection with or when handling the battery module but at the same time lead in part or entirely to the battery module becoming damaged are only introduced if their use is necessary.

In addition, in accordance with the invention, a control arrangement for an intrinsically safe battery module of a vehicle is provided. The control arrangement is suitable for transferring the battery module into the safe state wherein the prevailing state of the battery module is continuously monitored and evaluated and the safe state into which the battery module is to be transferred is a state in which effects of a defective battery module are reduced, wherein means for the transfer into the safe state in dependence upon the vehicle state are provided. In addition, in accordance with the invention an intrinsically safe battery module is provided, wherein the intrinsically safe battery module can be controlled.

Further advantageous embodiments of the present invention are the subject matter of the dependent claims.

It is thus advantageous if, preferably where the battery module has been transferred into the safe state in which effects of a defective battery module are reduced, essentially no voltage prevails between the terminals of the battery module.

The voltage drop that is associated with said lack of voltage leads to as little voltage as possible and therefore to increased safety and to a reduction in the effects of a defective battery module on the environment.

In accordance with a further advantageous embodiment, the battery module is discharged as rapidly as possible so as to transfer the battery module into the safe state in which effects of a defective battery module are reduced.

The as rapid as possible discharge of the battery module leads to as little charge as possible of the battery module remaining and therefore to increased safety and to a reduction of the effects of a defective battery module.

It is preferred that a current by-pass is connected between the terminals of the battery module and/or a discharging device, in particular a discharge device, or a rapid discharging device, in particular an ultra-fast discharge device is used in the region of the battery module so as to transfer the battery module into the safe state in which effects of a defective battery module are reduced.

The circuit of a current by-pass in accordance with the invention between the terminals of the battery module, the use of a discharging device of the battery module and also the use of a rapid discharging device of the battery module leads to the effects of a defective battery module on the environment being reduced.

Advantageously, the vehicle state is an irregular vehicle state, in particular a vehicle state during a vehicle accident or after a vehicle accident and the safe state of the battery module is advantageously initiated as or after the irregular vehicle state occurs, and in said safe state the effects of a defective battery module on the environment are reduced.

When achieving a battery module that is intrinsically safe in the case of an irregular vehicle state, in particular a vehicle accident, it means that the demands on the electronics of a battery management system in relation to this can be considerably reduced. In addition, the safety in particular of battery systems having higher storage capacities, such as for example those used in the case of electric and hybrid vehicles, is significantly increased. In particular, hazards such as those that occur during or after first crash tests of plug-in vehicles and electric vehicles that are currently in series production are avoided.

It is preferred that the vehicle state is determined at least based on information from vehicle safety systems or in dependence upon a variable that represents the acceleration variable, wherein in particular it is provided that the variable is compared with at least one threshold value and the battery module is transferred into the safe state if the variable exceeds the threshold value.

The use of information obtained from driving safety systems leads in accordance with a further advantageous embodiment to increased reliability when determining and evaluating the vehicle state. Fundamentally, an incorrectly determined or incorrectly evaluated vehicle state can lead to an erroneously introduced measure. The number of erroneously introduced measures for reducing the effects of a defective battery module can therefore be considerably reduced by means of increasing the amount of information relating to the vehicle state, said erroneously introduced measures being introduced on the basis of incorrectly determined or incorrectly assessed vehicle states.

Advantageously, the acceleration variable is a linear acceleration and/or a rotational acceleration of the vehicle or of a vehicle component.

The process of determining and using the linear acceleration and/or the rotational acceleration of a vehicle or one of the vehicle components leads to the vehicle state being reliably determined.

It is preferred that the variable that represents an acceleration variable is determined by means of a MEMS sensor (microelectromechanical system sensors).

It is advantageous to use in accordance with the invention a MEMS sensor for determining the acceleration since MEMS sensors function reliably and are cost-effective.

In accordance with a further advantageous embodiment, the battery module is transferred into a safe state in which effects of a defective battery module are reduced, whilst taking into consideration at least the charge state of the battery module or the magnitude of mechanical integrity of the battery module or the pressure in the interior of the battery module or the temperature of the battery module or the temperature of the chemical system that is used in the battery module.

In order to select the measure that is to be initiated, it is important to take into consideration in accordance with the invention at least one of the state variables that characterize the state of the battery module or to take into consideration the chemical system that is used. It is possible to react with an appropriate measure at least in dependence upon the state of the battery module or the state of the chemical system that is used. Incorrect measures that possibly increase the effects of a defective battery module are avoided, as are incorrect, possibly exaggerated measures.

Furthermore, it is advantageous if at least one sensor is provided for the intrinsically safe battery module, said sensor being in particular a sensor for determining physical variables of the battery module in order to determine the prevailing state of the battery module.

In accordance with a further advantageous embodiment, means are provided for the intrinsically safe battery module, wherein the means for transferring the battery module into the safe state reduce effects of a defective battery module on the environment whilst taking into consideration a sensor-determined charge state of the battery module, and/or a sensor-determined magnitude of mechanical integrity of the battery module and/or a sensor-determined pressure in the interior of the battery module and/or a sensor-determined temperature of the battery module and/or a chemical system that is used in the battery module and/or a sensor-determined linear acceleration of the vehicle and/or a sensor determined rotational acceleration of the vehicle and/or a sensor-determined prevailing state of the battery module in relation to its safety.

Furthermore, it is advantageous if for the intrinsically safe battery module means are provided for predicting the temporal profile of at least the charging current of the battery module or the power capability of the battery module or the charge that can be drawn from the battery module.

Information and/or data that relates to the temporal profile of the charging current, the power capability and the charge of the battery module is used in accordance with a further advantageous embodiment to select an appropriate measure for reducing the effects of a defective battery.

Furthermore, it is advantageous if for the intrinsically safe battery module at least one actuator is provided for transferring the battery into the safe state.

Furthermore, it is advantageous if means are provided for the intrinsically safe battery module, said means controlling and operating an actuator system so as to transfer the battery into the safe state and being in particular a discharging device (discharge device) and/or a rapid discharging device (ultra-fast discharge device) and/or a device for providing a current by-pass and/or an actuator system for connecting the output voltage of the battery module, wherein using the actuator system, as or after the irregular vehicle state occurs, for the case that as or after the irregular vehicle state occurs, the pressure in the interior of the battery module remains unchanged, the rapid discharging device activates and the discharge process is performed as rapidly as possible and the battery module is monitored during the discharging process with regards to the temperature of the battery module, the pressure in the interior of the battery module and the charge state of the battery module, and for the case that during the discharging process, the pressure of the battery module increases quite significantly, the rate of the discharging process is reduced, or for the case that as or after the irregular vehicle state occurs, the pressure in the interior of the battery module decreases and a higher charge state of the battery module prevails, the discharging device activates and the discharging process is performed with currents that are as high as technically possible and the battery module is monitored during the discharging process with regards to the temperature of the battery module, the pressure in the interior of the battery module and the charge state of the battery module and for the case that during the discharging process, the pressure of the battery module increases quite significantly, the discharging current is reduced or for the case that as or after the irregular vehicle state occurs, the pressure in the interior of the battery module decreases and a lower charge state of the battery module prevails, the discharging device activates and the discharging process is performed with currents that are as low as technically possible or—with regards to the currents that are as high or low as technically possible—with average currents and the battery module is monitored during the discharging process with regards to the temperature of the battery module, the pressure in the interior of the battery module and the charge state of the battery module and for the case that during the discharging process, the pressure of the battery module increases quite significantly, the discharging current is reduced.

The advantageous embodiment, which is to introduce the measures that are to be taken in dependence upon the state of the battery module so as to reduce the effects of a defective battery module leads to the advantage that only appropriate measures are introduced. Incorrect measures that possibly increase the effects of a defective battery module are avoided, as are incorrect, possible exaggerated measures.

Advantageously, at least the above-described method or the device or the control arrangement or an intrinsically safe battery module is used at least in automotive technology or in energy technology.

### SHORT DESCRIPTION OF THE DRAWINGS

In the following section, the invention is explained with reference to exemplary embodiments, and further novel features can arise from said exemplary embodiments, said exemplary embodiments however do not limit the scope of the invention. The exemplary embodiments are illustrated in the drawings.

In the drawings:

FIG. 1 illustrates schematically an intrinsically safe battery module

FIG. 2 illustrates schematically the method for increasing safety when using intrinsically safe battery modules

and

FIG. 3 illustrates a basic circuit diagram of an intrinsically safe battery module.

### EMBODIMENTS OF THE INVENTION

FIG. 1 illustrates schematically an intrinsically safe battery module EB. In the case of an intrinsically safe battery module EB, the prevailing state of the battery module is continuously monitored and evaluated and the battery module is transferred into the safe state. The safe state into which the battery module is to be transferred is a state of the type in which effects of a defective battery module are reduced. For this purpose, the intrinsically safe battery module EB comprises by way of example a suitable sensor concept and actuator concept for achieving the intrinsic safety; the intrinsically safe battery module EB can be used by way of example in a vehicle.

The intrinsically safe battery module EB includes at least one cell module Z that includes at least one battery cell BZ. The at least one battery cell BZ is assembled from mechanical components and at least one electrochemical component. The electrochemical component is also described as the chemical system of the intrinsically safe battery module EB. In an exemplary manner, the at least one battery cell BZ is a lithium ion battery cell. Furthermore, it is preferred that a sensor system S is included with which it is possible to determine the voltage of the intrinsically safe battery module EB or the current with which the intrinsically safe battery module EB can be discharged or the temperature of the intrinsically safe battery module EB or the pressure in the interior of the intrinsically safe battery module EB. If the intrinsically safe battery module EB is used in a vehicle, it is advantageously possible in addition also to determine the linear acceleration of the vehicle or the rotational acceleration of the vehicle by means of the sensor system S.

In addition, it is preferred that at least one component BEP is included for identifying the battery state or for predicting battery states of the intrinsically safe battery module EB or for identifying or predicting battery state variables of the intrinsically safe battery module EB. In addition, it is preferred that an actuator system A1 for transferring the intrinsically safe battery module EB into a safe state is included, it is possible using said actuator system A1 to connect preferably at least one current by-pass between electrical connectors of the intrinsically safe battery module EB or to use a discharging device, in particular a discharge device, or a rapid discharging device, in particular an ultrafast discharge device, in the region of the intrinsically safe battery module EB. In order to facilitate their use, the discharging device and/or the rapid discharging device is connected to the connectors of the intrinsically safe battery module EB.

If the current by-pass is connected between the electrical connectors of the intrinsically safe battery module EB, an electrical current can flow between the electrical connectors of the intrinsically safe battery module EB without this current flowing through the electrochemical components of the at least one battery cell BZ of the intrinsically safe battery module EB. The current by-pass can also be connected between the connectors of the at least one battery cell BZ.

In addition, it is preferred that an actuator system A2 is included; it is possible using the actuator system A2 to at least control or vary the magnitude of the output voltage of the intrinsically safe battery module EB.

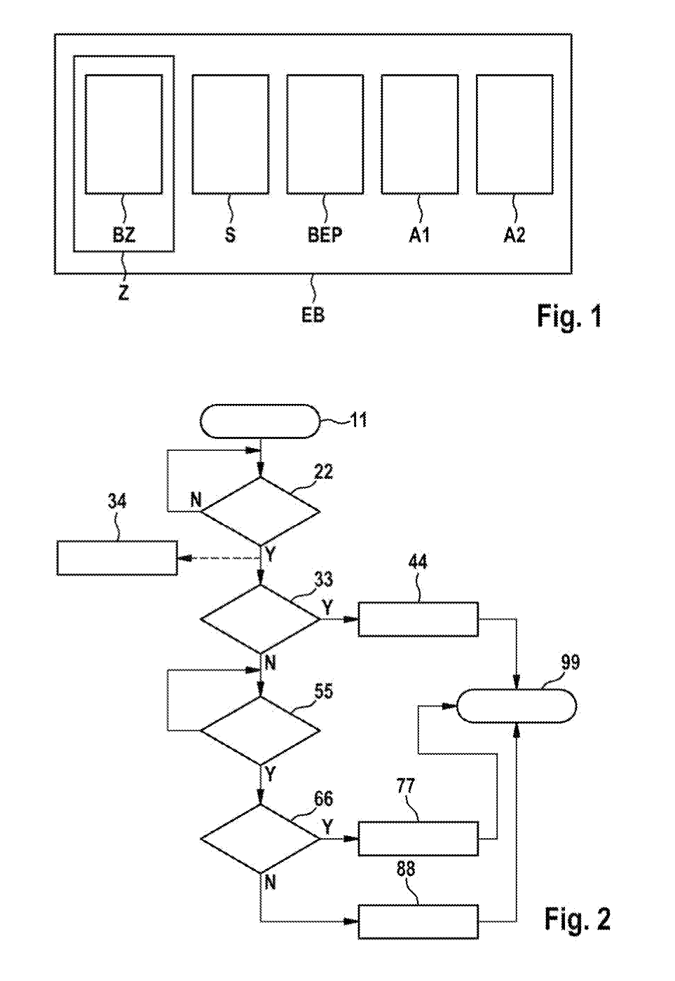

FIG. 2 illustrates schematically a method for increasing safety when using intrinsically safe battery modules EB. The method is introduced in a first method step 11. In a vehicle testing step 22 that follows said first method step, the vehicle is tested for whether or not an irregular vehicle state, in particular a vehicle accident, is present. For this purpose, by way of example a linear acceleration a or a rotational acceleration a of the vehicle or of a vehicle component is determined and evaluated. If an irregular vehicle state is not present, the vehicle testing step 22 is begun afresh and the test of the vehicle state is repeated.

If however an irregular vehicle state is present, initially a current by-pass is connected between the electrical connectors of the intrinsically safe battery module EB so that an electrical current can flow between the electrical connectors of the intrinsically safe battery module EB without this current having to flow through the electrochemical components of the at least one battery cell BZ of the intrinsically safe battery module EB. It is preferred that the pressure in the interior of the intrinsically safe battery module EB is tested in a first pressure testing step 33.

If the pressure in the interior of the intrinsically safe battery module EB is constant as or after the irregular vehicle state occurs, the first discharging step 44 is introduced. In this first discharging step 44, the discharging device is activated and the discharge of the intrinsically safe battery module EB is performed as rapidly as possible. The current required for the as rapid as possible discharge is selected in dependence upon the capacity of the battery cell BZ and can preferably be in a region of 300 A to 9000 A for each battery cell BZ. The intrinsically safe battery module EB is discharged by way of the rapid discharge device so as to perform the discharge as rapidly as possible. During the discharging process, it is possible to monitor the intrinsically safe battery module EB with regards to at least its temperature or its pressure in the interior or its charge state by way of example by means of the sensor system S. If during the charging process the pressure in the interior of the intrinsically safe battery module EB increases significantly, the rate of the discharging process is reduced. The rate of the increase in pressure in the interior and/or the value of the pressure that is in each case achieved in the interior of the intrinsically safe battery module EB can be determined and evaluated in order to test and establish whether the pressure in the interior of the intrinsically safe battery module increases significantly. An exemplary value of the pressure in the interior of the intrinsically safe battery module EB which if achieved and/or exceeded can result in a critical state of the intrinsically safe battery module EB is between 3 bar to 7 bar.

In order to reduce the rate of the discharging process, the intrinsically safe battery module EB is then no longer discharged by way of the rapid discharging device but rather by way of the discharging device.

After concluding the first discharging step 44, the method is concluded in the concluding step 99.

However, if the pressure in the interior of the intrinsically safe battery module EB is not constant as or after the irregular vehicle state occurs, a test is performed in a second pressure testing step 55 as to whether the pressure in the interior of said intrinsically safe battery module EB is decreasing.

If the pressure in the interior of the intrinsically safe battery module EB is not decreasing, the pressure testing step 55 is repeated.

If however the pressure in the interior of the intrinsically safe battery module EB decreases, the charge state of the intrinsically safe battery module EB is determined and evaluated in the charge state testing step 66. If the charge state is high, in particular approximately 80% to 100%, the discharging device is activated in a second discharging step 77 and the discharge of the intrinsically safe battery module EB can be performed with currents that are as high as technically possible. The currents that are as high as technically possible are preferably approximately 1000 A to 10000 A. The strength of the current that is as high as possible with which it is possible to discharge the intrinsically safe battery module EB is derived from the electrical, electrotechnical and electrochemical characteristics of the intrinsically safe battery module EB. During the discharging process, it is possible to monitor the intrinsically safe battery module EB with regards to at least its temperature or its pressure in the interior or its charge state. If during the discharging process the pressure in the interior of the intrinsically safe battery module EB increases significantly, the discharging current is reduced. The rate of the increase in pressure in the interior and/or the respective value of the pressure achieved in the interior of the intrinsically safe battery module EB can be determined and evaluated in order to test and establish whether the pressure in the interior of the intrinsically safe battery module EB is increasing significantly. An exemplary value of the pressure in the interior of the intrinsically safe battery module EB which if achieved and/or exceeded can result in a critical state of the intrinsically safe battery module EB is between 3 bar to 7 bar.

After concluding the second discharging step 77, the method is concluded in concluding step 99.

However, if the charge state of the intrinsically safe battery module EB however is not high but rather is low, by way of example below 50% of the regular charge state, in a third discharging step 88, the discharging device activates and the discharge of the intrinsically safe battery module EB can be performed with currents that are as high as technically possible or—with regards to the currents that are as high or as low as technically possible—with average currents. The currents that are as low as technically possible or average are preferably approximately 10 A or rather 100 A. The lowest possible and average intensity of the current with which the intrinsically safe battery module EB can be discharged is derived from the electrical, electrotechnical and electrochemical characteristics of the intrinsically safe battery module EB. During the discharging process, it is possible to monitor the intrinsically safe battery module EB with regards to at least its temperature or its pressure in the interior or its charge state. If during the discharging process the pressure in the interior of the intrinsically safe battery module EB increases significantly, the discharging current is reduced. After concluding the third discharging step 88, the method is concluded in the concluding step 99. The rate of the increase in pressure in the interior and/or the value of the pressure that is in each case achieved in the interior of the intrinsically safe battery module EB can be determined and evaluated so as to test and establish whether the pressure in the interior of the intrinsically safe battery module EB is increasing significantly. An exemplary value of the pressure in the interior of the intrinsically safe battery module EB which if achieved and/or exceeded can result in a critical state of the intrinsically safe battery module EB is between 3 bar to 7 bar.

All the state variables of the intrinsically safe battery modules EB that are specified in the above-described method steps are determined with the aid of a sensor system S. The testing and evaluation of the state variables is performed preferably by means of the component BEP for identifying the battery state. The actuating processes that are performed in the method steps are undertaken by way of example by means of actuator systems A1, A2.

As an alternative to the sensor system S that is a part of the intrinsically safe battery module EB, it is possible to use other sensors for determining state variables of the intrinsically safe battery module EB, said sensors being arranged outside the intrinsically safe battery module EB. By way of example, said sensors can be sensors that are associated with equipping a vehicle in which the intrinsically safe battery module EB is installed. In an exemplary manner, said sensors can be sensors for determining electrical variables—such as current or voltage—by way of example for determining the on-board voltage, or for determining the temperature in the interior of the vehicle or pressure. The sensors for determining electrical variables are by way of example sensors for determining the on-board network voltage of the vehicle and/or sensors that are used in connection with the on-board network structure device. The sensors for determining temperature in the interior of the vehicle are by way of example sensors of the climate control device of the vehicle and/or sensors for determining the external temperature of the vehicle.

In addition to the above-described method, there are further exemplary possibilities for increasing safety in connection with the use of an intrinsically safe battery module EB: If an irregular vehicle state is established in the vehicle testing step 22, it is possible in accordance with a further advantageous embodiment of the invention in the information transmission step 34 to transmit information regarding the vehicle state to other systems preferably by means of suitable communication interfaces.

These other systems can be located within or also outside the vehicle. These systems can be by way of example vehicle safety systems or vehicle state determining systems. These other systems are by way of example crash sensor systems of restraint systems, by way of example an airbag, and/or a proximity radar of a system for adaptive speed control and/or acceleration sensors of the electronic stability program of the vehicle and/or the anti-lock braking system of the vehicle.

The above-described method steps for transferring the battery module EB into an intrinsically safe state can be used in addition to the actual purpose of use in dependence upon irregular vehicle states furthermore also during other vehicle states and/or operating states of the intrinsically safe battery module EB. In these other situations, it is possible for processes to take place by means of which the intrinsically safe battery module EB can be put into a defective state. Processes of this type are by way of example processes in which the intrinsically safe battery module EB is subjected to intense accelerations that do not normally occur during normal operation of the vehicle, by way of example rear-impact collisions and/or driving over an obstacle, by way of example a curbstone, at high speed.

In addition to using an intrinsically safe battery module EB in automotive technology as described, it is also possible to use an intrinsically safe battery module EB in energy technology.

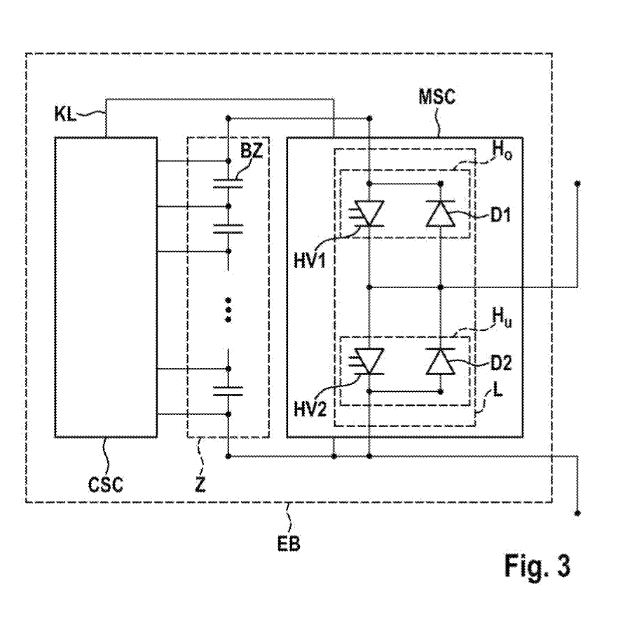

FIG. 3 illustrates a basic circuit diagram of an intrinsically safe battery module EB.

The basic circuit diagram illustrates a cell module Z, a cell monitoring electronic system CSC and a module monitoring electronic system MSC.

The cell module Z includes at least one battery cell BZ. In an exemplary manner, the at least one battery cell BZ is a lithium ion battery cell.

The cell monitoring electronic system CSC includes a sensor system S for determining a state of the at least one battery cell BZ. The cell monitoring electronic system CSC is used to monitor the at least one battery cell BZ within the cell module Z.

The module monitoring electronic system MSC communicates with the cell monitoring electronic system CSC. The communication between the cell monitoring electronic system CSC and the module monitoring electronic system MSC can occur in a wireless manner or in a manner connected by wire by way of a communication line KL. Within the scope of the communication between the module monitoring electronic system MSC and the cell monitoring electronic system CSC, data is transmitted by way of at least one battery cell BZ. In addition, the module monitoring electronic system MSC comprises a sensor system S for monitoring the cell module Z.

The module monitoring electronic system MSC can operate in dependence upon the state of the at least one battery cell BZ or the cell module Z. The module monitoring electronic system MSC includes for this purpose at least two semiconductor gates HV1 an HV2 that can be switched on or switched off and two diodes D1 and D2. Each semiconductor gate that can be switched off and a diode form a half bridge arrangement. An upper half bridge arrangement is identified in the drawing by Hₒ, a lower half bridge arrangement is identified by Hᵤ. The upper half bridge arrangement and the lower half bridge arrangement form a power switch L that can be controlled.

In the normal case, by way of example, the regular vehicle state, if the upper half bridge arrangement Hₒ is switched on, the lower half bridge arrangement Hᵤ is switched off. In this state, the cell monitoring electronic system CSC performs a process of equalizing the charge between at least two battery cells BZ.

If the module monitoring electronic system MSC identifies an imminent excess charge of at least the cell module Z or of at least a battery cell BZ, the upper half bridge arrangement Hₒ is switched off and the lower half bridge arrangement Hᵤ is switched on. As a consequence, a further charge of at least the cell module Z or of at least the battery cell BZ is prevented and as a consequence, the excess charge of at least the cell module Z or of at least the battery cell BZ is stopped.

If the module monitoring electronic system MSC identifies an imminent deep discharge of at least the cell module Z or of at least one battery cell BZ, the upper half bridge arrangement Hₒ is switched off and the lower half bridge arrangement Hᵤ is switched on. The current that flows through the cell module Z then flows by way of the lower half bridge arrangement Hᵤ; at least the cell module Z or at least the battery module BZ are not further discharged.

If the module monitoring electronic system MSC identifies an imminent overload at least of the cell module Z or at least of a battery cell BZ, by way of example in the case of charging currents that are too high, the upper half bridge arrangement Hₒ is switched off and the lower half bridge arrangement Hᵤ is switched on. The current that flows through the cell module Z then flows by way of the lower half bridge arrangement Hᵤ at least the cell module Z or at least the battery cell BZ are not loaded with unacceptably high discharging currents.

If the module monitoring electronic system MSC identifies an imminent overload of at least the cell module Z or at least a battery cell BZ by means of charging currents that are too high, by way of example in the case of extremely low temperatures, by way of example in the case of temperatures below 0° Celsius, of a battery cell BZ, the upper half bridge circuit arrangement Hₒ is switched off and the lower half bridge arrangement Hᵤ is switched on. The current that flows through the cell module Z then flows by way of the lower half bridge arrangement Hᵤ; at least the cell module Z or at least the battery cell BZ are not loaded with unacceptably high charging currents in the case of low temperatures. The intention behind avoiding unacceptably high charging currents in the case of low temperatures is to avoid lithium plating.

If the module monitoring electronic system MSC indicates by way of the sensor system S that an irregular vehicle state is present, in particular an accident of the vehicle, the module can be discharged by way of one of the half bridges Hₒ, Hᵤ. For this purpose, the upper half bridge arrangement Hₒ is operated as a resistor that can be controlled and the lower half bridge arrangement Hᵤ is switched on. The cell module Z then does not output any voltage to its connectors and is nevertheless discharged. The discharging process lasts by way of example from a few hours to a few days.

In addition to the monitoring arrangement of the battery cells as illustrated in FIG. 3 by means of a cell monitoring electronic system, a dedicated battery cell monitoring arrangement is possible in each case by means of a cell monitoring electronic system CSC that is allocated to one of the at least one battery cells BZ. For this purpose, each battery cell BZ is allocated a dedicated sub-cell monitoring electronic system. These sub-cell monitoring electronic systems communicate with a main cell monitoring electronic system. The main cell monitoring electronic system communicates with the module monitoring electronic system MSC that inter alia operates in dependence upon the information that is communicated by the main cell monitoring electronic system.

1. A method for transferring a battery module of a vehicle into a safe state comprising:
continuously monitoring a prevailing state of the battery module;
evaluating the prevailing state of the battery module; and
transferring the battery module into a safe state in dependence upon a vehicle state, the safe state being a type of a state in which effects of a defective battery module are reduced.

2. The method as claimed in claim 1, further comprising:
preventing voltage from prevailing between terminals of the battery module when the battery module has been transferred into the safe state.

3. The method as claimed in claim 1, further comprising:
discharging the battery module as rapidly as possible so as to transfer the battery module into the safe state.

4. The method as claimed in claim 1, further comprising:
connecting at least one of a current by-pass and a discharging device between terminals of the battery module in order to transfer the battery module into the safe state.

5. The method as claimed in claim 1, further comprising:
transferring the battery module into the safe state as or after an irregular vehicle state occurs, the irregular vehicle state occurring during a vehicle accident or after a vehicle accident.

6. The method as claimed in claim 1, further comprising:
determining the vehicle state based on information from driving safety systems and/or in dependence upon a vehicle variable representing an acceleration variable;
comparing the vehicle variable with at least one threshold value; and
transferring the battery module into the safe state if the vehicle variable exceeds the at least one threshold value.

7. The method as claimed in claim 6, wherein the acceleration variable is the linear acceleration and/or the rotational acceleration of the vehicle or of a vehicle component.

8. The method as claimed in claim 6, further comprising:
determining the vehicle variable with a MEMS sensor.

9. The method as claimed in claim 1, further comprising:
transferring the battery module into the safe state whilst taking into consideration a charge state of the battery module, a magnitude of mechanical integrity of the battery module, a pressure in an interior of the battery module, a temperature of the battery module, and/or a chemical system used in the battery module.

10. A control arrangement for an intrinsically safe battery module of a vehicle, comprising:
a transfer structure configured to transfer the battery module into a safe state in dependence upon a vehicle state,
wherein said control arrangement is configured to continuously monitor and evaluate a prevailing state of the battery module, and
wherein the safe state is a type of state configured to reduce effects of a defective battery module.

11. An intrinsically safe battery module, comprising:
a control arrangement including a transfer structure configured to transfer the battery module into a safe state in dependence upon a vehicle state,
wherein said control arrangement is configured to continuously monitor and evaluate a prevailing state of the battery module, and
wherein the safe state is a type of state configured to reduce effects of a defective battery module.

12. The intrinsically safe battery module as claimed in claim 11, further comprising:
at least one sensor system configured to determine physical variables of the battery module so as to determine the prevailing state of the battery module.

13. The intrinsically safe battery module as claimed in claim 11, wherein the transfer structure is configured to transfer the battery module into the safe state whilst taking into consideration a sensor-determined charge state of the battery module, a sensor-determined magnitude of mechanical integrity of the battery module, a sensor-determined pressure in an interior of the battery module, a sensor-determined temperature of the battery module, a chemical system that is used in the battery module, a sensor-determined linear acceleration of the vehicle, a sensor determined rotational acceleration of the vehicle, and/or a sensor-determined prevailing state of the battery module in relation to its safety.

14. The intrinsically safe battery module as claimed in claim 11, further comprising:
a predicting structure configured to predict a temporal profile of a charging current of the battery module, a power capability of the battery module, and/or a charge that can be drawn from the battery module.

15. The intrinsically safe battery module as claimed in claim 11, further comprising:
at least one actuator system configured to transfer the battery into the safe state.

16. The intrinsically safe battery module as claimed in claim 15, further comprising:
a controller configured to control and operate the at least one actuator system so as to transfer the battery module into the safe state; and
a discharging device,
wherein the actuator system is used as or after an irregular vehicle state occurs,
wherein
for the case that as or after the irregular vehicle state occurs, a pressure in an interior of the battery module remains unchanged, the discharging device activates and a discharge process is performed as rapidly as possible and the battery module is monitored during the discharging process with regards to temperature of the battery module, the pressure in the interior of the battery module and a charge state of the battery module and for the case that during the discharging process, the pressure of the battery module increases quite significantly, the rate of the discharging process is decreased, or
for the case that as or after the irregular vehicle state occurs, the pressure in the interior of the battery module decreases and a higher charge state of the battery module prevails, the discharging device activates and the discharge is performed with currents that are as high as technically possible and the battery module is monitored during the discharging process with regards to the temperature of the battery module, the pressure in the interior of the battery module and the charge state of the battery module, and for the case that during the discharging process, the pressure of the battery module increases quite significantly, the discharging current is reduced, or
for the case that as or after the irregular vehicle state occurs, the pressure in the interior of the battery module decreases and a lower charge state of the battery module prevails, the discharging device activates and the discharge is performed with currents that are as low as technically possible or—with regards to the currents that are as high as technically possible and low as technically possible—with average currents and the battery module is monitored during the discharging process with regards to the temperature of the battery module, the pressure in the interior of the battery module and the charge state of the battery module and for the case that during the discharging process the pressure of the battery module increases quite significantly, the discharging current is reduced.

17. The method as claimed in claim 1, wherein the method is used in automotive technology and/or in energy technology.
